(19) United States
(12) Patent Application Publication
(10) Pub. No.: US 2008/0031081 A1
(43) Pub. Date: Feb. 7, 2008

(54) Mixing device for delivering a resin or other products mixed with a foaming gas

(75) Inventor: Riccardo Rigolio, Oligiate Olona (Varese) (IT)

Correspondence Address: HEDMAN & COSTIGAN P.C., 1185 AVENUE OF THE AMERICAS, NEW YORK, NY, 10036, US

(73) Assignee: Rigo S.r.l.

(21) Appl. No.: 11/880,832

(22) Filed: Jul. 24, 2007

(30) Foreign Application Priority Data
Jul. 28, 2006 (IT) MI2006U000277

(51) Int. Cl. B01F 15/02

(52) U.S. Cl. 366/131

(57) ABSTRACT

A mixing device for delivering a resin mixed with a foaming gas comprises a body including a fitting for a container for holding a material to be delivered, the body comprising an inner cavity coupled to a delivery opening and to the container through a coupling duct, thereby the material to be delivered may be conveyed to the delivery opening to be delivered therefrom, the duct comprising a mixing device including a plurality of sectors of different contours, thereby defining differentiated sections for the passage of the material to be delivered.

### BACKGROUND OF THE INVENTION

The present invention relates to a mixing device, specifically designed for delivering a resin or other products mixed with a foaming gas.

As is known, for applying foaming resins, such as polyurethane, are conventionally used delivery devices or guns, allowing to withdraw the polyurethane material held in a container or vessel together with the foaming gas.

The product, which is ejected in a foam form, can be used and applied in an adjustable manner.

A conventional type of delivery gun comprises a delivery gun body, to which a polyurethane or other product bottle can be coupled, communicating with the inside of a tubular element which is perforated at a free end portion thereof and is longitudinally traversed by a sliding rod.

This sliding rod has a beveled or conical end portion thereof, designed for shutting of a perforated conical end portion of the tubular element.

In particular, a sliding movement of said rod will make free an annular opening at the end of the tubular element thereby allowing the polyurethane or other resins and foaming agent to exit the tubular element and bottle.

The displacement amount of said rod will control a changing of the annular opening size, and, accordingly, of the amount of polyurethane or other product to be delivered.

The operator can easily adjust the amount of delivered product, by a trigger lever coupled to said rod.

In particular, the liquid and gas held in said bottle are mixed with one another in the delivery gun, as they exit the bottle and enter the gun fitting.

The characteristics of the delivered product will depend, as it should be apparent, on a good mixing of the components.

### SUMMARY OF THE INVENTION

Accordingly, the aim of the present invention is to provide a device designed for improving the mixing of the foaming gas with the resin material or other product, to be applied to a delivery gun or other delivery device.

Within the scope of the above mentioned aim, a main object of the invention is to provide such a device which can be easily applied to a conventional type of delivery gun or other delivery device, while delivering a better mixed product.

Another object of the present invention is to provide such a device which can be easily applied to conventional delivery devices and guns.

Yet another object of the present invention is to provide such a mixing device which can be made at a comparatively low cost.

According to one aspect of the present invention, the above mentioned aim and objects, as well as yet other objects, which will become more apparent hereinafter, are achieved by a mixing device, for delivering a resin or a product mixed with a foaming gas, characterized in that said mixing device is applied to a body including a fitting for a container of a material to be delivered, said body comprising an inner cavity coupled to a delivery opening and said container through a coupling duct, so as to allow the material to be delivered to pass to the delivery opening to be delivered therefrom, said duct comprising a mixing device including a plurality of sectors having different contours to define different passage sections for the material to be delivered.

### BRIEF DESCRIPTION OF THE DRAWINGS

Further characteristics and advantages of the present invention will become more apparent hereinafter from the following detailed disclosure of a preferred, though not exclusive, embodiment of the invention, which is illustrated, by way of an indicative, but not limitative example, in the accompanying drawings, where:

FIG. 1 is a side elevation view of a delivery gun the mixing device according to the present invention may be applied to;

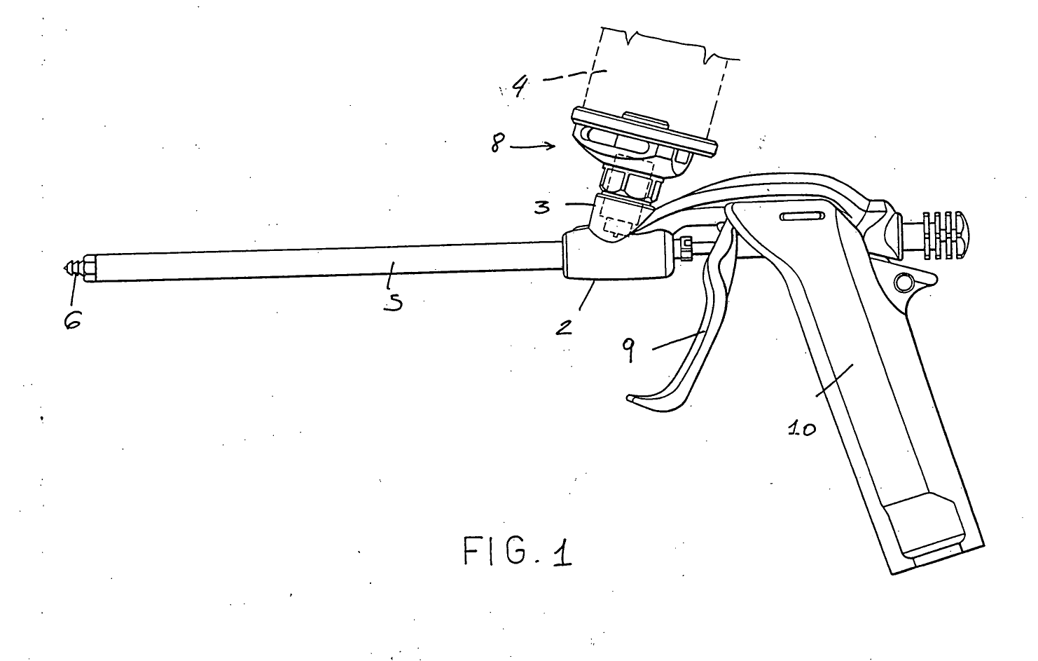

FIG. 2 is an exploded side elevation view of that same delivery gun;

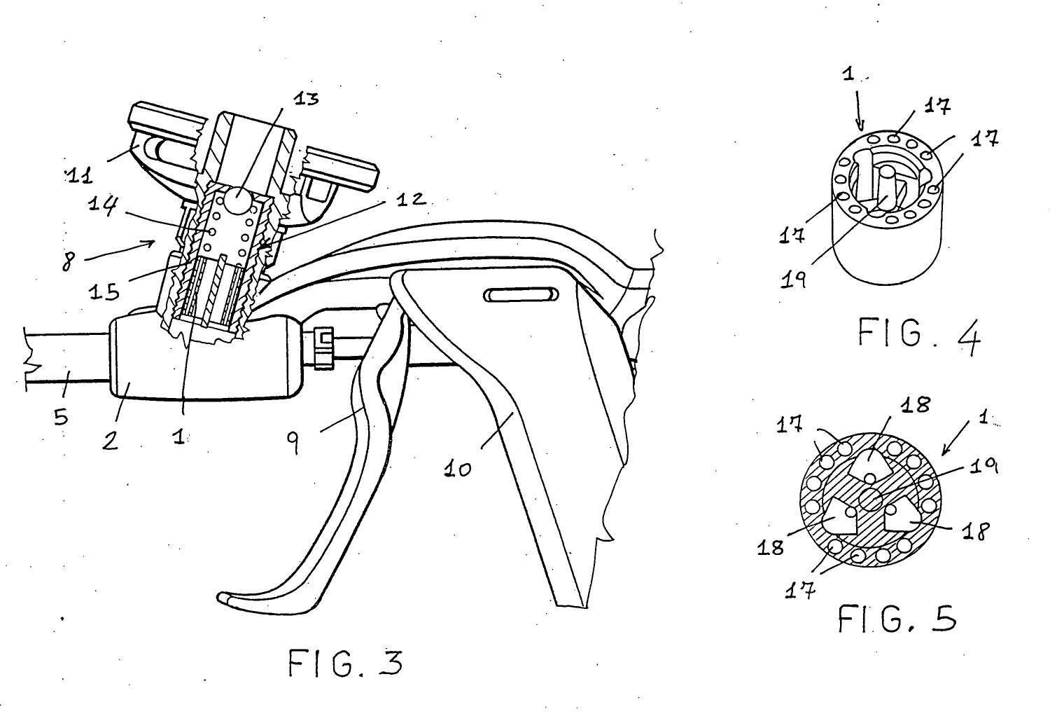

FIG. 3 is a further side elevation view, on an enlarged scale and as partially cross-sectioned, of the region of the screw fitting of the delivery gun;

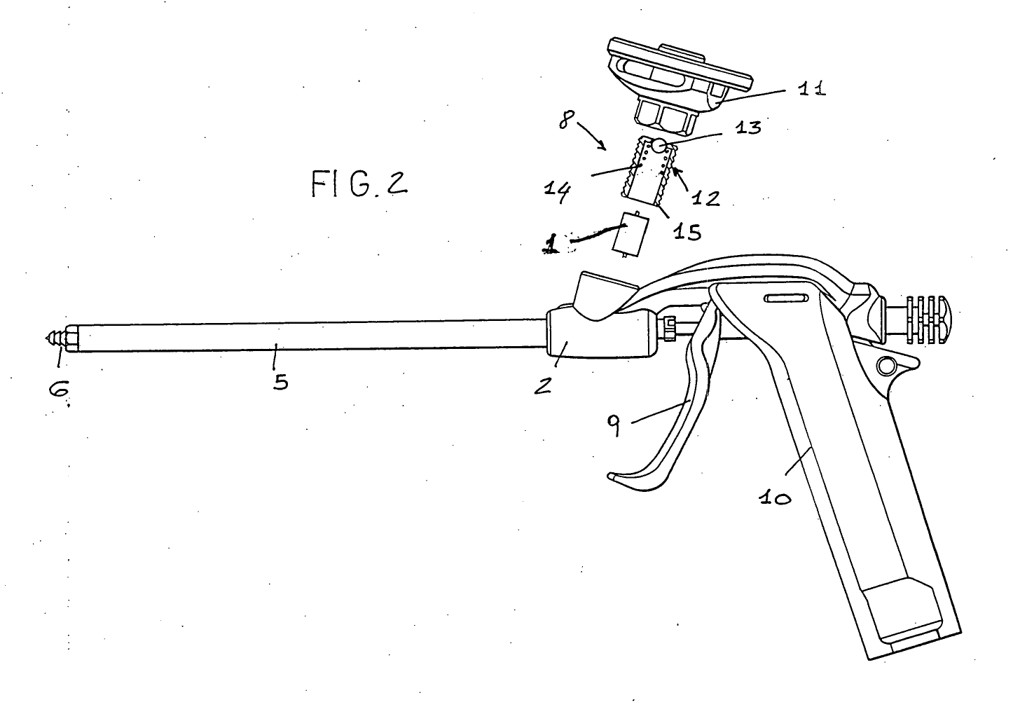

FIG. 4 is a further perspective view showing the mixing device according to one aspect of the present invention;

FIG. 5 is a top plan view of that same mixing device; and

FIGS. 6 to 13 are further perspective views of different embodiments of the mixing device according to the invention.

### DESCRIPTION OF THE PREFERRED EMBODIMENTS

With reference to the number references of the above mentioned figures, the mixing device according to the present invention, which has been generally indicated by the reference number 1, comprises a mixing device body 2, including a fitting 3 for a container or vessel 4 for a material to be delivered, for example a polyurethane and foaming gas holding bottle.

To said body 2 is coupled an extension element 5, including a tubular element having a free end portion provided with a delivery opening or port 6.

The inner cavity of the tubular element 5 is coupled to said container 4, through a coupling duct, thereby the material to be delivered is adapted to pass to the delivering opening 6 to be delivered therefrom.

A delivery rod, which is not shown, is arranged in the cavity of the tubular element 5 and is adapted to longitudinally slide in said cavity.

Said rod has a front conical or beveled end portion, designed for shutting of the delivery opening or port 6, in a closed condition thereof, and, by sliding backward, being adapted to open in an adjustable manner the delivery opening 6, owing to its beveled or conical pattern.

The backward sliding of the rod 7 is driven by a driving lever 9, associated with the gun body 2 and which can be controlled by a hand of a user gripping the delivery gun by a handle 10.

The delivery gun, in particular, comprises a screw fitting 8, to which said bottle 4 is coupled.

To the end, the screw fitting 8 comprises a threaded attachment 11 and a non-return valve 12, comprising a ball element 13 urged by a coil spring 14, housed in a cylindric body 15.

According to the present invention, downstream of the non return or check valve 12 a mixer device 1 including a plurality of sectors having different contours is arranged.

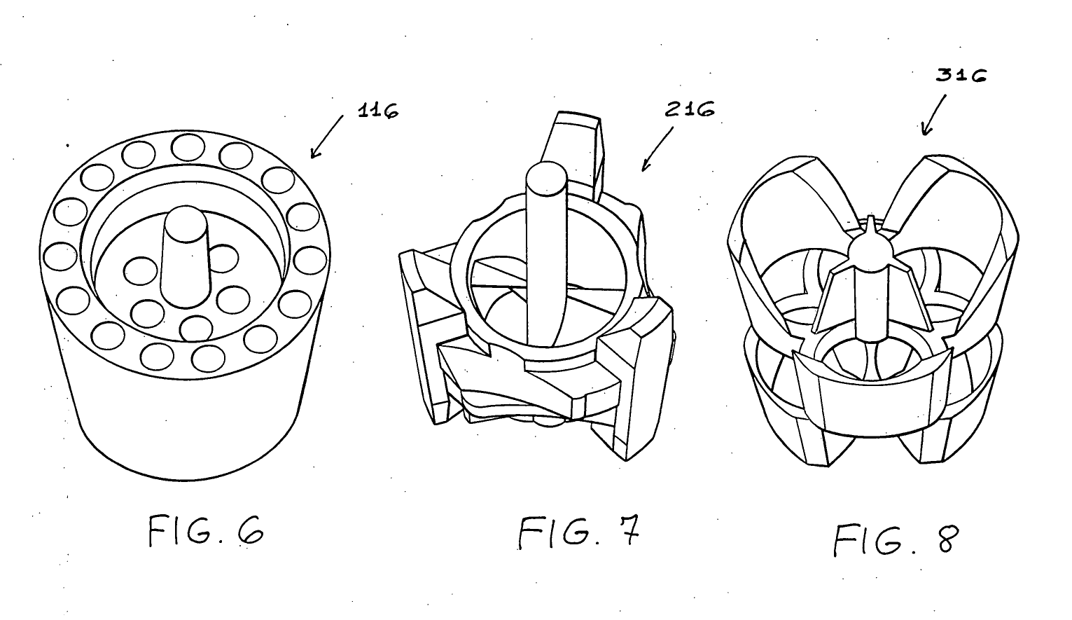

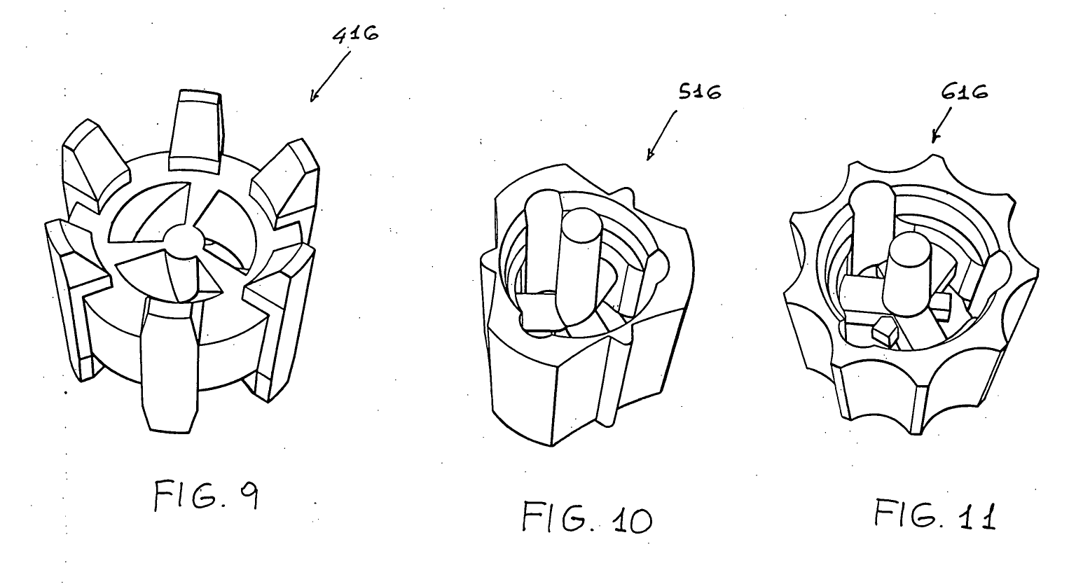

More specifically, said mixing device 1 comprises a plurality of peripheral holes 17 and a plurality of innermost ports 18, optionally separated by a central separating diaphragm 19, as is clearly shown in FIGS. 4 and 5.

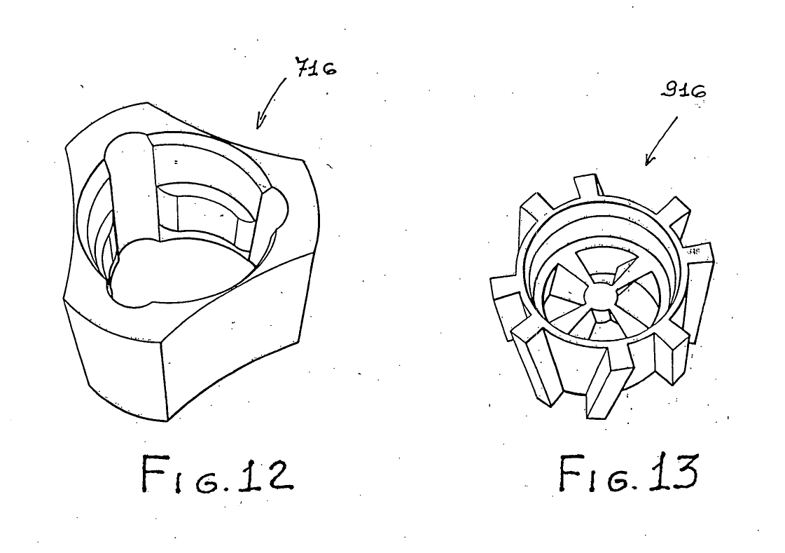

In this connection it should be apparent that the size and shapes of the peripheral holes, inner ports and separating diaphragm may be changed, as shown by way of an example in FIGS. 6 to 13, which illustrate different embodiments of the mixing device, which have indicated by the reference numbers 116, 216, 316, 416, 516, 616, 716 and 916.

Said mixing devices, after having being engaged in the respective cylindric body 15, will define said peripheral holes in cooperation with the inner wall of said cylindric body.

Advantageously, to perform a better mixing operation, the inner ports of the mixing device 1 have a size which is larger than those of the peripheral holes.

It has been found that the invention fully achieves the intended aim and objects.

In fact, the invention has provided a mixing device which is adapted to deliver a product the components of which have been mixed in an improved manner, without the need that the operator changes conventional delivery operations.

In practicing the invention, the used materials, as well as the contingent size and shapes, can be any, depending on requirements.

1. A mixing device, for delivering a resin or a product mixed with a foaming gas, characterized in that said mixing device is applied to a body including a fitting for a container of a material to be delivered, said body comprising an inner cavity coupled to a delivery opening and said container through a coupling duct, so as to allow the material to be delivered to pass to the delivery opening to be delivered therefrom, said duct comprising a mixing device including a plurality of sectors having different contours to define different passage sections for the material to be delivered.

2. A mixing device, according to claim 1, characterized in that said mixing device is applied to a body including a screw adapter, to which a bottle is applied, and having a threaded fitting and a non-return valve including a ball element urged by a coil spring housed in a cylindric body.

3. A mixing device, according to claim 1, characterized in that said mixing device is arranged downstream of the non-return valve.

4. A mixing device, according to claim 1, characterized in that said mixing device comprises a plurality of peripheral holes and a plurality of innermost ports.

5. A mixing device, according to claim 4, characterized in that said peripheral holes and innermost ports are separated by a separating central diaphragm.

6. A mixing device, according to claim 5, characterized in that said peripheral holes, innermost ports and separating diaphragm have a variable size and shape.

7. A mixing device, according to claim 1, characterized in that said mixing device comprises a contoured body engaged in a cylindric body of the non-return valve.

8. A mixing device, according to claim 4, characterized in that said peripheral hole size and shapes are defined by the contoured body housed in an inner wall of the cylindric body.

9. A mixing device, according to claim 8, characterized in that said innermost ports have a size larger than that of said peripheral holes.

10. A mixing device, according to claim 1, characterized in that to the body of said mixing device is connected an extension element including a tubular element having a free end portion including a delivery opening.

11. A mixing device, according to claim 10, applied to a delivery device, characterized in that the inner cavity of the tubular element is coupled to said container through said coupling duct, thereby the material to be delivered may be conveyed to the delivery opening to be delivered therefrom.

12. A mixing device, according to claim 1, characterized in that said mixing device is applied to a delivery gun including a delivery rod arranged in the cavity of the tubular element and adapted to longitudinally slide in said cavity.

13. A mixing device applied to a delivery gun, according to claim 12, characterized in that said rod has a front conical end portion adapted to shut of the delivery opening in a closed position and, by backward sliding, being adapted to adjustably open said delivery opening.

14. A mixing device to be applied to a delivery gun, according to claim 13, characterized in that the backward sliding movement of said rod is driven by a driving lever coupled to the body of the delivery gun and which can be driven by a hand of the user gripping the delivery gun by a gripping handle.
